(19) United States
(12) Patent Application Publication
(10) Pub. No.: US 2025/0288953 A1
(43) Pub. Date: Sep. 18, 2025

(54) COLDFACE-LESS REGENERATIVE THERMAL AND CATALYTIC OXIDIZERS AND COMPONENTS AND METHODS OF USE OF SAME

(71) Applicant: Teal Sales Incorporated, Lynnwood, WA (US)

(72) Inventors: Jarrad Stephen Markley, Lynnwood, WA (US); Robert James-Coartney Cox, Milford, MI (US)

(21) Appl. No.: 19/075,368

(22) Filed: Mar. 10, 2025

Related U.S. Application Data
(60) Provisional application No. 63/564,393, filed on Mar. 12, 2024.

(51) Int. Cl. B01D 53/34; B01D 53/76; B01J 19/30

(52) U.S. Cl. CPC B01D 53/343; B01D 53/76; B01J 19/30; B01D 2258/0283; B01J 2219/30246; B01J 2219/3085

(57) ABSTRACT

Disclosed herein are components, systems, and methods for oxidizing a waste gas to produce a flue gas. Embodiments of a regenerative oxidizer include a heat exchanger supported within a heat transfer chamber without the use of a coldface. The regenerative oxidizer may include an inlet into the heat transfer chamber that is laterally aligned with at least a portion of the heat exchanger. The heat exchanger includes a heat exchange block having at least one lateral passageway extending therethrough, and at least one vertical passageway extending through a top face of the heat exchange block, but is devoid of any vertical passageways extending through a bottom face of the heat exchange block.

### CROSS-REFERENCE TO RELATED APPLICATION

This application claims the benefit of Provisional Application No. 63/564,393, filed Mar. 12, 2024, the disclosure of which is hereby incorporated by reference in its entirety herein.

### BACKGROUND

### Technical Field

The present disclosure relates to regenerative oxidizers and regenerative catalytic oxidizers, components, and methods of operation and assembly thereof. More specifically, this disclosure relates to regenerative oxidizers that are devoid of a coldface.

### Description of the Related Art

Regenerative thermal oxidizers (RTOs) and regenerative catalytic oxidizers (RCOs), referred to herein collectively as regenerative oxidizers (ROs), are typically used for oxidation of organic compounds (OCs), which may include volatile organic compounds (VOCs) and/or hazardous air pollutants (HAPs) in waste gas streams produced in many industrial processes. RTOs and RCOs are differentiated by a catalyst layer, which is used in RCO operation and absent in RTO operation.

Referring to FIGS. 1 and 2, known ROs 10 often include a number of heat transfer chambers, commonly referred to as heat recovery chambers. The known RO 10 may include two or more heat transfer chambers (e.g., a first heat transfer chamber 12 and a second heat transfer chamber 14) that are each in fluid communication with a combustion chamber 16. While the number of heat transfer chambers is often even (e.g., including matching “pairs”), TO's may also include odd numbers of heat transfer chambers.

Waste gas (indicated by arrow 18) is introduced into the RO 10 to flow through one of the heat transfer chambers (e.g. the first heat transfer chamber 12 as shown in FIG. 1) to preheat the waste gas 18. In the combustion chamber 16, the waste gas 18 is heated further (e.g., to between about 1,450° F. and 2,000° F. in an RTO, or to between about 700° F. and 950° F. in an RCO) such that the OCs within the waste gas 18 are oxidized to produce CO₂ and H₂O vapor, resulting in a flue gas (indicated by arrow 20), which flows through other heat transfer chambers of the RO 10 (e.g. the second heat transfer chamber 14 as shown in FIG. 1) and transfers thermal energy from the flue gas 20 to the second heat transfer chamber 14.

After a certain time period, a flow direction of the waste gas 18 within the RO 10 is changed (e.g., reversed, diverted, etc.). As shown in FIG. 2, the RO 10 may include one or more valves 22 that are repositioned (e.g., opened/closed, shifted, etc.) to change/reverse the flow direction of the waste gas 18. In a first orientation (as shown in FIG. 1), the one or more valves 22 direct the waste gas 18 to first flow through the first heat transfer chamber 12, then through the combustion chamber 16, then through the second heat transfer chamber 14, and then exiting the RO 10 (e.g., exhausted to the atmosphere). In a second orientation (as shown in FIG. 2), the one or more valves 22 direct the waste gas 18 to first flow through the second heat transfer chamber 14, then through the combustion chamber 16, then through the first heat transfer chamber 12, and then exiting the RO 10 (e.g., exhausted to the atmosphere).

The changeable/reversable flow direction enables efficient use of thermal energy within the RO 10, such that the waste gas 18 that is introduced into the RO 10 in FIG. 2 flows through the second heat transfer chamber 14 that was previously heated by the flue gas 20 exiting the combustion chamber 16. After the waste gas 18 exits the combustion chamber 16 (as the flue gas 20) and enters the first heat transfer chamber 12, heat is transferred from the flue gas 20 to the first heat transfer chamber 12. That transferred heat will then be used to heat the waste gas 18 once the one or more valves 22 are actuated to change/reverse the flow direction of the waste gas 18 (as shown in FIG. 1).

The first heat transfer chamber 12 includes a heat exchanger 24 that facilitates the transfer of heat to the waste gas 18 on its way to the combustion chamber 16, and from the flue gas 20 on its way out of the combustion chamber 16, depending on the orientation of the one or more valves 22. The heat exchanger 24 typically includes structured or random media. Structured media includes a plurality of blocks 26 with holes extending therethrough that form passageways for the waste gas 18/flue gas 20 to flow through as the waste gas 18/flue gas 20 advances through the first heat transfer chamber 12 toward/away from the combustion chamber 16. Random media includes pieces, typically with odd shapes that are arranged non-uniformly. Known random media shapes include (but are not limited to) saddle, snowflake, dog bone, and bowtie.

The heat exchanger 24 (e.g., the plurality of blocks 26 or the random media) are each typically formed from ceramic. However, other materials may also be used. As shown, the heat exchanger 24 is supported by a structural support system, commonly referred to as a coldface 28 that supports the heat exchanger 24 within the first heat transfer chamber 12. A coldface 28 is a porous structure (e.g., a plurality of beam members, expanded metal, grates, cages, etc.) that allows passage of the waste gas 18/flue gas 20 into and out of the first heat transfer chamber 12 (typically in a vertical direction). The coldface 28 is often made of metallic (e.g., carbon steels, stainless steels, duplex, or other higher alloys) or ceramic materials, but may include others. The RO 10 includes a hopper 30 positioned beneath the coldface 28 that primarily distributes the flow of the waste gas 18 as it enters the first heat transfer chamber 12 via an inlet/outlet 32 positioned within (e.g., at the bottom or a side of the hopper 30). As shown, the hopper 30 is devoid of any structured or random media.

The second heat transfer chamber 14 may be similar to (e.g., identical to) the first heat transfer chamber 12, such that the description of the first heat transfer chamber 12 above is also applicable to the second heat transfer chamber 14. Accordingly, the second heat transfer chamber 14 may include a heat exchanger 34 (similar to the heat exchanger 24), including a plurality of blocks 36 (similar to the plurality of blocks 26), supported by a coldface 38 (similar to the coldface 28) above a hopper 40 (similar to the hopper 30) positioned beneath the coldface 28 that primarily distributes the flow of the waste gas 18 as it enters the second heat transfer chamber 14 via an inlet/outlet 42 positioned within (e.g., at the bottom of or a side of the hopper 40).

If the RO 10 is an RCO, a catalyst 17 (e.g., a layer of material) may be present within one or more of the heat transfer chambers 12, 14 (e.g., positioned above the heat exchanger 24). The catalyst 17 is typically either a base metal or a precious metal that gives rise to a chemical reaction with incoming OCs within the waste gas 18. This chemical reaction lowers the required reaction temperature within the combustion chamber 16. As a result, less heat and therefore less external energy are needed to convert the pollutants within the waste gas 18. If the RO 10 is an RTO, the catalyst 17 would not be present and temperatures within the combustion chamber 16 are increased.

Failure of the coldface 28, 38 is a failure condition for the RO 10. Due to the moisture and/or chemical content within the waste gas 18, the coldface 28 is susceptible to corrosion. In some ROs, the waste gas 18 may be saturated with water vapor. Higher priced alloys such as 304SS or 316SS may be used in the construction of the coldface 28, 38 to prevent general corrosion, however in certain industries and applications, there are additional corrosive materials such as acidic and/or alkaline compounds that warrant, even higher alloy materials.

Sodium chlorides and/or sodium hydroxides are present in some of the major industries where RTOs/RCOs are deployed. The presence of these compounds can lead to a phenomenon called stress corrosion cracking (SCC). SCC occurs when stainless steels (e.g., 304SS and 316SS) are used for a coldface in the presence of chlorides, high temperature, and stress (from the weight of the ceramic media on the coldface). The use of higher alloy materials (e.g., duplex stainless or nickel alloy steels, such as RA330, Carpentar 20, 310SS, Hastelloy, and AL6XN) can be used to mitigate the propagation of SCC. However, the use of these materials can be cost prohibitive.

Additionally, the coldface 28, 38 of known ROs 10 are susceptible to deformation caused by exposure to high temperature events/situations. The RO 10 is a thermal oxidation device that relies on high temperatures in the combustion chamber 16 (e.g., around 1,500° F. to 2,000° F. for RTOs and around 700° F. to 950° F. in RCOs), to destroy pollutants/OCs in the waste gas 18. Although the heat exchanger 24 in each of the heat transfer chambers provides a buffer, reducing the temperature of the flue gas 20 that passes through the coldface 28, 38, occasionally “thermal events” occur. These thermal events include high temperature excursions that reach the coldface 28, 38, such as fires or certain maintenance modes (e.g., self-cleaning referred to as a “bakeout”).

During a high temperature event, metal fatigue of the coldface 28, 38 can occur compromising the structural integrity of the coldface 28, 38 and resulting in premature failure. Failure of the coldface 28, 38 may result in the heat exchanger 24, 34 (e.g., the plurality of blocks 26, 36) also being compromised. If this occurs, the heat exchanger 24, 34 must be removed prior to repair/replacement of the coldface 28, 38 (for safety and to reduce the load). Often the majority of the heat exchanger 24, 34 cannot be reused due to rough handling/breakage. This results in replacement of the heat exchanger 24, 34 and increased operating costs.

Accordingly, RTO and RCO systems and methods of operating them without the use of a coldface are described herein.

### BRIEF SUMMARY

Embodiments described herein provide systems and methods of treating waste gas at elevated temperatures to produce a clean, flue gas. Additional embodiments described herein include components of a heat exchanger for ROs, and methods of assembly and operation of said systems.

According to one embodiment, a regenerative oxidizer includes a first heat transfer chamber and a heat exchanger positioned within the first heat transfer chamber. The regenerative oxidizer further includes a second heat transfer chamber and a combustion chamber that is in fluid connection with both the first and second heat transfer chambers. The regenerative oxidizer defines a fluid flow path that enters the first heat transfer chamber along a horizontal direction through an opening that is aligned with a portion of the heat exchanger along the horizontal direction, passes through the heat exchanger along a vertical direction that is perpendicular to the horizontal direction, passes through the combustion chamber, enters the second heat transfer chamber, and then exits the second heat transfer chamber.

According to one embodiment, method of assembling a heat exchanger within a heat transfer chamber of a regenerative oxidizer includes arranging a plurality of first heat exchange blocks in a first layer. Each of the first heat exchange blocks includes a lateral passageway that extends through a respective body of each of the first heat exchange blocks along a lateral direction, and a plurality of vertical passageways that each extend through the respective body of each of the first heat exchange blocks along a vertical direction that is perpendicular to the lateral direction.

The method further includes orienting the plurality of first heat exchange blocks in the first layer such that the lateral passageway of each of the first heat exchange blocks is aligned with an opening of the heat transfer chamber along the lateral direction, and arranging a plurality of second heat exchange blocks in a second layer. Each of the second plurality of heat exchange blocks includes a plurality of vertical passageways that each extend through a respective body of each of the second heat exchange blocks along the vertical direction. The method further includes orienting the plurality of second heat exchange blocks in the second layer such that the plurality of vertical passageways of the first heat exchange blocks are aligned with the plurality of vertical passageways of the second heat exchange blocks along the vertical direction.

According to one embodiment, a method of assembling a heat exchanger within a heat transfer chamber of a regenerative oxidizer includes placing a plurality of pieces of heat exchange media within the heat transfer chamber such that the plurality of pieces are supported by a floor of the heat transfer chamber. The method further includes stacking additional ones of the pieces of heat exchange media on top of the plurality of pieces supported by the floor such that the additional ones of the pieces of heat exchange media are aligned with an opening of the heat transfer chamber along a horizontal direction. The opening is above the floor with respect to a vertical direction that is perpendicular to the horizontal direction. The method further includes increasing a height of a stack of the pieces of heat exchange media until the height of the stack is greater than a height of the opening. The height of the stack and the height of the opening are both measured along the vertical direction.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings. The headings and Abstract of the Disclosure provided herein are for convenience only and do not interpret the scope or meaning of the embodiments.

FIG. 1 is a schematic view of a known regenerative oxidizer during a first phase of operation.

FIG. 2 is a schematic view of the known regenerative oxidizer illustrated in FIG. 1 during a second phase of operation.

FIG. 3 is a schematic view of a regenerative oxidizer according to one embodiment, during a first phase of operation.

FIG. 4 is a schematic view of the regenerative oxidizer illustrated in FIG. 3, during a second phase of operation.

FIG. 5 is a schematic view of a regenerative oxidizer according to one embodiment, during a first phase of operation.

FIG. 6 is a schematic view of the regenerative oxidizer illustrated in FIG. 5, during a second phase of operation.

FIG. 7 is a front elevation view of a heat exchange block according to one embodiment.

FIG. 8 is a rear elevation view of the heat exchange block illustrated in FIG. 7.

FIG. 9 is a first side elevation view of the heat exchange block illustrated in FIG. 7.

FIG. 10 is a second side elevation view of the heat exchange block illustrated in FIG. 7.

FIG. 11 is a top plan view of the heat exchange block illustrated in FIG. 7.

FIG. 12 is a bottom plan view of the heat exchange block illustrated in FIG. 7.

FIG. 13 is a cross-sectional view of the heat exchange block illustrated in FIG. 9, taken along line 13-13.

FIG. 14 is a cross-sectional view of the heat exchange block illustrated in FIG. 9, taken along line 14-14.

FIG. 15 is a front elevation view of another heat exchange block according to one embodiment.

FIG. 16 is a first side elevation view of the heat exchange block illustrated in FIG. 15.

FIG. 17 is a top plan view of the heat exchange block illustrated in FIG. 15.

FIG. 18 is a bottom plan view of the heat exchange block illustrated in FIG. 15.

FIG. 19 is a cross-sectional view of the heat exchange block illustrated in FIG. 16, taken along line 19-19.

FIG. 20 is a front elevation view of another heat exchange block according to one embodiment.

FIG. 21 is a first side elevation view of the heat exchange block illustrated in FIG. 20.

FIG. 22 is a top plan elevation view of the heat exchange block illustrated in FIG. 20.

FIG. 23 is a cross-sectional view of a heat exchanger being assembled within a heat transfer chamber, according to one embodiment, during a phase of assembly.

FIG. 24 is a cross-sectional view of the heat exchanger illustrated in FIG. 23 during another phase of assembly.

FIG. 25 is a cross-sectional view of the heat exchanger illustrated in FIG. 23 during another phase of assembly.

FIG. 26 is a cross-sectional view of the heat exchanger illustrated in FIG. 23 during another phase of assembly.

FIG. 27 is a cross-sectional view of a heat exchanger being assembled within a heat transfer chamber, according to one embodiment, during a phase of assembly.

### DETAILED DESCRIPTION

In the following description, certain specific details are set forth to provide a thorough understanding of various disclosed embodiments. However, one of ordinary skill in the relevant art will recognize that the disclosed embodiments may be practiced without one or more of these specific details, or with other methods, components, materials, etc. In other instances, well-known structures associated with regenerative oxidizers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. Reference herein to two elements “facing” or “facing toward” each other indicates that a straight line can be drawn from one of the elements to the other of the elements without contacting an intervening solid structure.

The term “aligned” as used herein in reference to two elements along a direction means a straight line that passes through one of the elements and that is parallel to the direction will also pass through the other of the two elements. The term “between” as used herein in reference to a first element being between a second element and a third element with respect to a direction means that the first element is closer to the second element as measured along the direction than the third element is to the second element as measured along the direction. The term “between” includes, but does not require that the first, second, and third elements be aligned along the direction.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein.

The headings and Abstract of the Disclosure provided herein are for convenience only and do not interpret the scope or meaning of the embodiments.

The present disclosure is directed toward components, systems and methods for oxidizing/combusting OCs in waste gas streams produced in many industrial processes. The ROs described herein are constructed such that the heat exchangers within the heat transfer chambers are not supported by a coldface, and are instead, according to one embodiment, resting directly on a floor of the heat transfer chamber. The inlet/outlet of the heat transfer chambers, according to embodiments of the disclosure, are positioned laterally with respect to the heat exchanger, rather than vertically.

As described above, catastrophic failure of a coldface (e.g., collapse) typically also results in collapse of the heat exchanger that was supported by the coldface. After the heat exchanger (e.g., a plurality of blocks that make up the heat exchanger) collapses, it is often the case that the heat exchanger will be rendered inoperable and need to be replaced.

The coldface-less ROs described herein remove all of the failure conditions associated with a coldface in a RO by eliminating the coldface entirely. Instead, embodiments of coldface-less ROs include a self-supporting heat exchanger. For example, the heat exchanger may include a three-dimensional array of blocks of heat exchange media arranged such that respective two-dimensional layers are supported by the layer(s) beneath, with the bottom layer resting directly on the floor of the heat transfer chamber. Thus, embodiments of coldface-less ROs may include blocks that facilitate the flow of gases (e.g., waste/flue gas) horizontally, thereby removing the need for a coldface.

Accordingly, embodiments of a coldface-less RO provide a number of benefits compared to known ROs (e.g., the RO 10) that include a coldface supporting each of the heat exchangers. For example, a RO devoid of a coldface removes corrosion, mechanical, and heat-related failure conditions of the coldface as possible failure conditions for the TO.

Other advantages gained by the use of a RO devoid of a coldface include reduced maintenance time/cost (as there is no need to halt operations to inspect the coldface). Access to other areas within the RO may be easier (e.g., because of the lower profile of the heat exchanger) compared to traditional ROs, which may result in faster and/or safer inspections as there is no longer a need to access a confined space below the coldface, which may be loaded with/supporting the heat exchange, which may weigh in excess of tens of thousands of pounds. Further there is no need to wait for the coldface area to “cool” prior to internal inspection of the diverter valves.

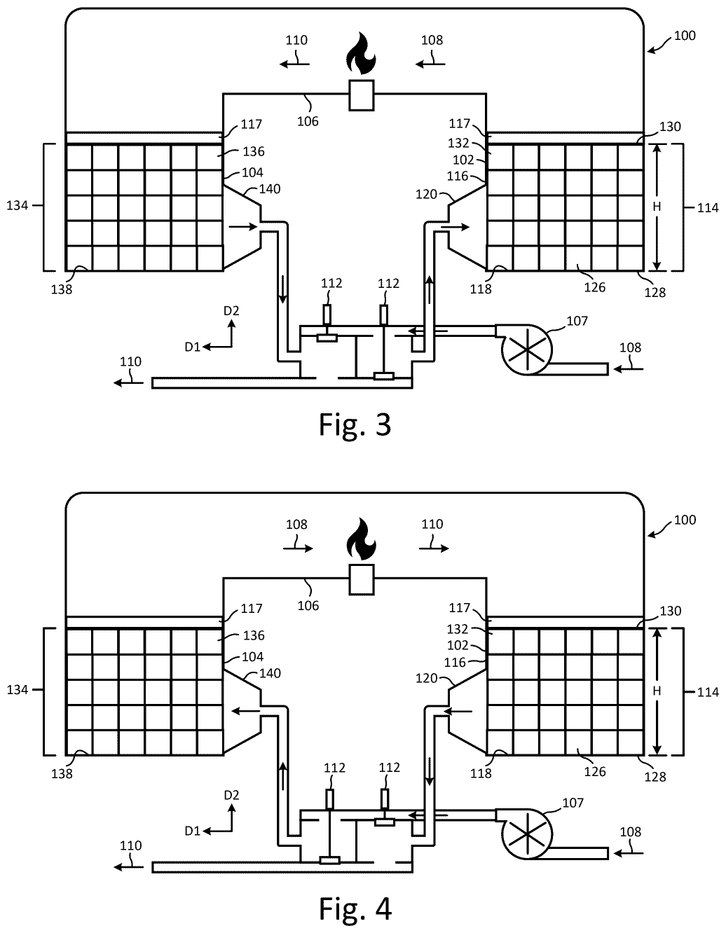

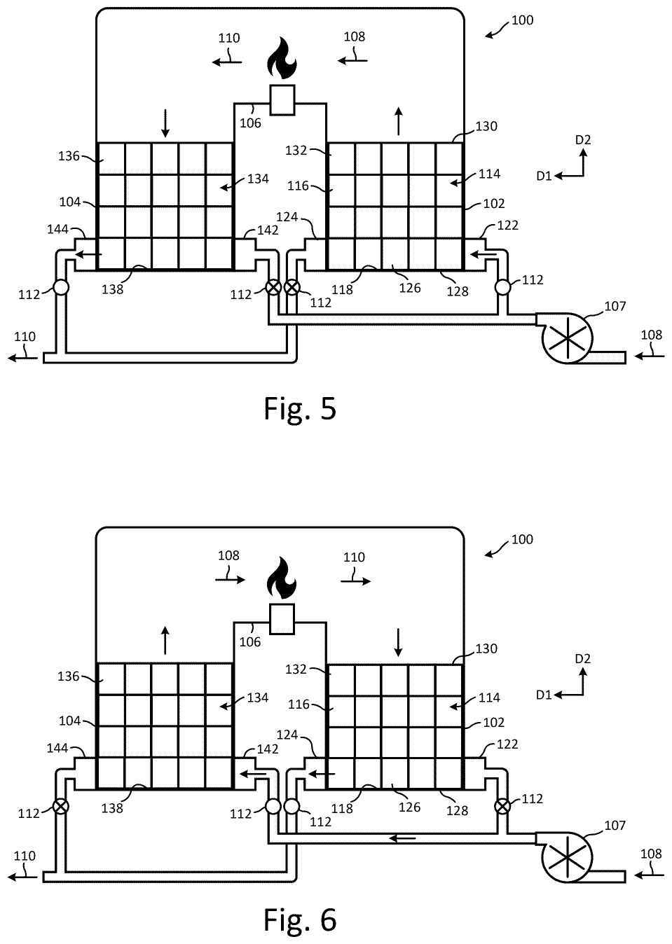

Referring to FIGS. 3 to 6, a RO 100 may include a plurality of heat transfer chambers (e.g., a first heat transfer chamber 102 and a second heat transfer chamber 104) that are each in fluid communication with a combustion chamber 106. As shown in FIGS. 3 and 4, the RO 100 may be an RCO including a catalyst 117 (described in further detail below). However, according to one embodiment, the RO 100 as shown and described in FIGS. 3 and 4 may be an RTO with the catalyst 117 removed/absent. Similarly, the RO 100 may be an RTO devoid of the catalyst 117 as shown in FIGS. 5 and 6. However, according to one embodiment, the RO 100 as shown and described in FIGS. 5 and 6 may be an RCO that includes the catalyst 117 (e.g., positioned as shown in FIGS. 3 and 4).

An inlet gas, for example a waste gas (indicated by arrow 108) including OCs that are to be removed from the inlet gas by the RO 100, may be introduced into the RO 100. As shown, one or more fans 107 or other induction device(s), either internal (i.e., part of the RO 100) or external to the RO 100 move (e.g., push and/or pull) the waste gas 108 along a flow path (indicated by arrows) through one of the heat transfer chambers (e.g. the first heat transfer chamber 102 as shown in FIGS. 3 and 5) to preheat the waste gas 108 (e.g., via a heat exchanger 114 within the first heat transfer chamber 102).

In the combustion chamber 106, the waste gas 108 may be heated further (e.g., to between about 1,450° F. and 2,000° F. in an RTO, or to between about 700° F. and 950° F. in an RCO) such that the OCs within the waste gas 108 are oxidized to produce flue gas (indicated by arrow 110). The flue gas 110 flows through another one of the heat transfer chambers (e.g. the second heat transfer chamber 104 as shown in FIGS. 3 and 5) and transfers thermal energy from the flue gas 110 to the second heat transfer chamber 104 (e.g., via a heat exchanger 134 within the second heat transfer chamber 104).

Although shown including two heat transfer chambers in the illustrated embodiment, the RO 100 may include other numbers of heat transfer chambers (e.g., two or more, between two and ten, such as two, three, four, five, six, seven, eight, nine, or ten) that are each in fluid communication with a combustion chamber 106. While the number of heat transfer chambers may be even (e.g., including matching “pairs”), the RO 100 may include an odd number of heat transfer chambers. The odd number of heat transfer chambers may enable one or more of the heat transfer chambers to undergo a purge when not in fluid connection with another of the heat transfer chambers.

After a certain time period, a flow direction of the waste gas 18 within the RO 100 may be changed (e.g., reversed). According to one embodiment, the RO 100 may include one or more valves 112 that are opened/closed to change/switch the flow direction of the waste gas 108. In a first orientation (as shown in FIGS. 3 and 5), the one or more valves 112 may direct the waste gas 108 to flow through the first heat transfer chamber 102, then through the combustion chamber 106, and then through the second heat transfer chamber 104, before exiting the RO 100 (e.g., exhausting to the atmosphere) as the flue gas 110.

In a second orientation (as shown in FIGS. 4 and 6), the one or more valves 112 may direct the waste gas 108 to flow through the second heat transfer chamber 104, then through the combustion chamber 106, and then through the first heat transfer chamber 102, before exiting the RO 100 (e.g., exhausting to the atmosphere as the flue gas 110).

According to some embodiments, the changeable/reversable flow direction enables efficient use of thermal energy within the RO 100, such that the waste gas 108 that is introduced into the RO 100 in FIGS. 4 and 6 flows through the second heat transfer chamber 104 that was previously heated by the flue gas 110 exiting the combustion chamber 106. After the waste gas 108 exits the combustion chamber 106 (as the flue gas 110) and enters the first heat transfer chamber 102, heat is transferred from the flue gas 110 to the first heat transfer chamber 102. That transferred heat may then be used to heat the waste gas 108 once the one or more valves 112 are actuated to change the flow direction of the waste gas 108 (as shown in FIGS. 3 and 5).

The first heat transfer chamber 102 may include a heat exchanger (e.g., a first heat exchanger 114) that facilitates the transfer of heat to the waste gas 108 on its way to the combustion chamber 106, and from the flue gas 110 on its way out of the combustion chamber 106, depending on the orientation of the one or more valves 112. The first heat exchanger 114 may include a plurality of blocks 116 with holes extending therethrough that form passageways for the waste gas 108/flue gas 110 to flow through as the waste gas 108/flue gas 110 advances through the first heat transfer chamber 102 toward/away from the combustion chamber 106.

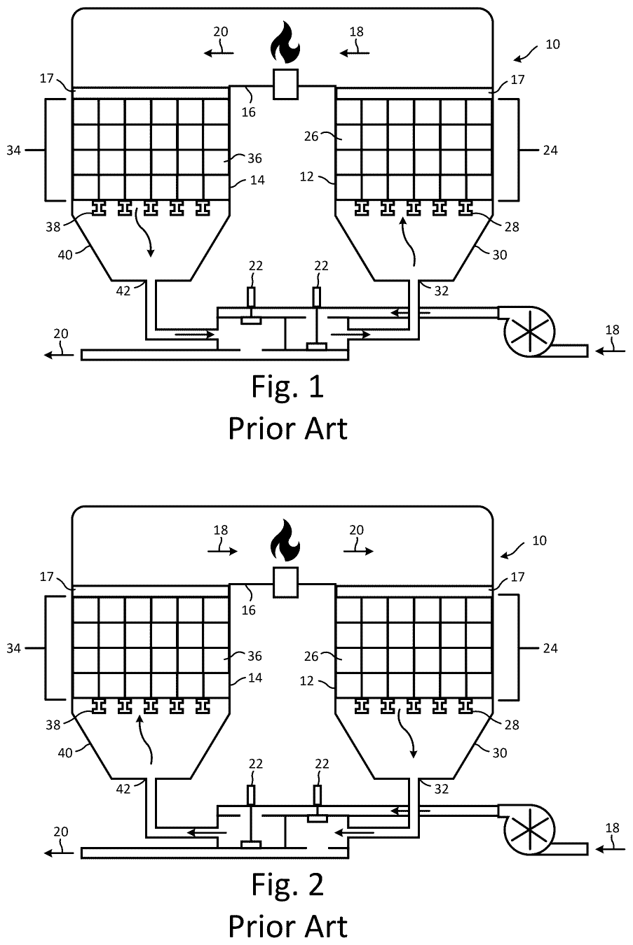

According to some embodiments, the plurality of blocks 116 may be formed from ceramic. As shown, the first heat exchanger 114 is supported by a surface (e.g., a floor 118) of the first heat transfer chamber 102. The RO 100, as shown, is devoid of a coldface (e.g., the coldface 28, 38 as described in reference to FIGS. 1 and 2). The floor 118 may be impermeable to the waste gas 108 and the flue gas 110 preventing passage of the waste gas 108 and the flue gas 110 vertically through the bottom of the first heat transfer chamber 102. The RO 100 may include an inlet/outlet 120 (as shown in FIGS. 3 and 4) or a separate inlet 122 and outlet 124 (as shown in FIGS. 5 and 6). Similar to the catalyst 117 as described above, the number and arrangement of the inlets and outlets (e.g., a single inlet/outlet 120 per heat transfer chamber or multiple/separate inlets 122 and outlets 124 per heat transfer chamber) are swappable among the embodiments of the RO 100 described herein.

As shown, the inlet/outlet 120 or the inlet 122 and the outlet 124 may intersect the first heat transfer chamber 102 at a location that is aligned (e.g., along a lateral direction D1 that is perpendicular to a vertical direction D2, within a lateral plane that is normal to a vertical direction D1) with the first heat exchanger 114. The inlet/outlet 120 or the inlet 122 and the outlet 124 may be positioned above (i.e., higher than) the floor 118. According to one embodiment, the plurality of blocks 116 may be arranged in a number of rows.

Each row, as shown in the illustrated embodiment, may include a line of the blocks 116, but may include additional blocks in the same plane (i.e., extending into and out of the page along a transverse direction that is perpendicular to both the lateral direction D1 and the vertical direction D2) to form a layer of blocks 116. Multiple layers of the blocks 116 may be arranged vertically to form a stack of the blocks 116. A bottom row 126 may be directly supported by the floor 118, and each subsequent row may be supported by the row(s) beneath. The array of blocks 116 may include a number of columns, with each column including blocks stacked vertically (i.e., aligned with respect to the vertical direction D2).

The first heat exchanger 114 may have a height H measured vertically (e.g., along the second direction D2) from a bottom surface 128 of the bottom row 126 (that directly abuts the floor 118) to a top surface 130 of a top row 132 of the plurality of blocks 116. As shown, the intersection of the inlet/outlet 120 or the inlet 122 and the outlet 124 may be at a location that is between the bottom surface 128 and the top surface 130 with respect to the vertical direction D2.

According to one embodiment, the inlet/outlet 120 or the inlet 122 and the outlet 124 may be aligned laterally with the bottom row 126 of the plurality of blocks 116. The inlet/outlet 120 or the inlet 122 and the outlet 124 may further be aligned with one or more additional rows adjacent to and above the bottom row 126, depending on a size and shape of the inlet/outlet 120, the inlet 122, the outlet 124, and/or the plurality of blocks 116. As shown, the inlet/outlet 120 or the inlet 122 and the outlet 124 may be shaped so as to distribute the waste gas 108 to one or more of the rows of the plurality of blocks 116 (e.g., the one or more rows including the bottom row 126).

The second heat transfer chamber 104 may be similar to the first heat transfer chamber 102, such that the description of the first heat transfer chamber 102 above is also applicable to the second heat transfer chamber 104. Accordingly, the second heat transfer chamber 104 may include a heat exchanger (e.g., a second heat exchanger 134 similar to the heat exchanger 114), including a plurality of blocks 136 (similar to the plurality of blocks 116) supported by a surface (e.g., a floor 138) of the second heat transfer chamber 104. A second inlet/outlet 140 (similar to the inlet/outlet 120) or second inlet 142 and second outlet 144 (similar to the inlet 122 and the outlet 124) may intersect the second heat transfer chamber 104, thereby fluidly connecting the second heat transfer chamber 104 to an inlet source of the waste gas 108 and the outlet for the flue gas 110.

If the RO 100 is an RCO (as shown in FIGS. 3 and 4), a catalyst 117 may be present within one or more of the heat transfer chambers 102, 104 (e.g., positioned above the heat exchanger 114, 134). The catalyst 117 may be a base metal or a precious metal that gives rise to a chemical reaction with incoming OCs within the waste gas 108. This chemical reaction may lower the reaction temperature within the combustion chamber 106. As a result, less heat and therefore less external energy may be needed to convert the pollutants within the waste gas 108 and the flue gas 110. If the RO 100 is an RTO (as shown in FIGS. 5 and 6), the catalyst 117 would not be present. Accordingly, the RO 100 may be convertible to operate as either an RCO (with the catalyst 117) or as an RTO (devoid of the catalyst 117).

The inlet/outlet 120 is not restricted to use with the catalyst 117 and may be interchangeable with the inlet 122 and the outlet 124 of the embodiment shown in FIGS. 5 and 6, and the inlet 122 and the outlet 124 may be interchangeable with the inlet/outlet 120 as shown in the embodiment of FIGS. 3 and 4. Similarly, the valves 112 may be swapped between embodiments of this disclosure (and/or substituted with other known valve types).

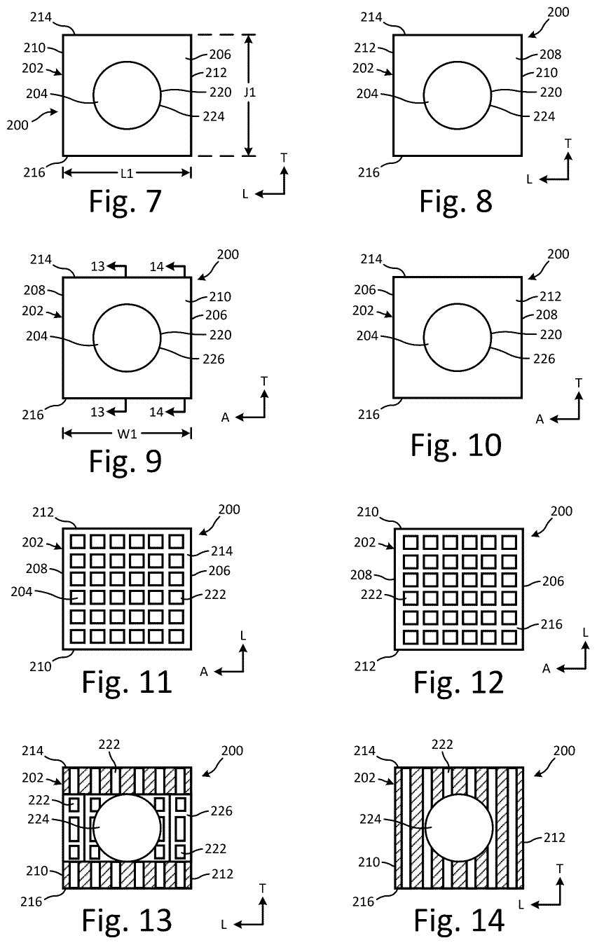

Referring to FIGS. 7 to 14, a heat exchange block 200 may be part of the heat exchanger 114, 134 of the RO 100 (as shown in FIGS. 3 to 6). For example, the plurality of blocks 116 may include a plurality of the heat exchange blocks 200. According to one embodiment, the heat exchange block 200 includes a body 202 with a plurality of passageways 204 extending therethrough.

The body 202 may be a rectangular prism (e.g., a cube or a cuboid). Alternatively, the body 202 may be another polygonal (e.g., hexagon, octagon), or non-polygonal shape. As shown, the body 202 may include a front face 206 and a rear face 208 opposite one another with respect to a width W1 of the heat exchange block 200. The body 202 may further include a first side face 210 and a second side face 212 opposite one another with respect to a length L1 of the heat exchange block 200. According to one embodiment, the width W1 may be perpendicular to the length L1, and the first and second side faces 210, 212 extend between the front face 206 and the rear face 208 (e.g., from the front face 206 to the rear face 208).

The body 202 may include a top face 214 and a bottom face 216 opposite one another with respect to a height J1 of the heat exchange block 200. According to one embodiment, the height J1 may be perpendicular to both the length L1 and the width W1, and the top and bottom faces 214, 216 may extend between the front face 206 and the rear face 208 (e.g., from the front face 206 to the rear face 208) and between the first side face 210 and the second side face 212 (e.g., from the first side face 210 to the second side face 212).

The plurality of passageways 204 may include horizontal passageways 220 and vertical passageways 222. The horizontal passageways 220 may extend into the body 202 through the front face 206 (e.g., along a direction parallel to the width W1), the rear face 208 (e.g., along the direction parallel to the width W1), the first side face 210 (e.g., along a direction parallel to the length L1), or the second side face 212 (e.g., along the direction parallel to the length L1). The horizontal passageways 220 may extend through an entirety of the body 202 (e.g., such that a horizontal passageway 220 that extends into the body 202 through the front face 206 exits the body 202 through the rear face 208).

The vertical passageways 222 may extend into the body 202 through the top face 214 (e.g., along a direction parallel to the height J1) and exit the body 202 through the bottom face 216 (e.g., such that the vertical passageway 222 extends through an entirety of the body 202 along the height J1).

According to one embodiment, the size, shape, number, or any combination thereof of the horizontal passageways 220 may differ from those of the vertical passageways 222. For example, at least some of the horizontal passageways 220 may be fewer and larger than at least some of the vertical passageways 222. For example, the plurality of passageways 204 may include few (e.g., about two) large horizontal passageways 220 and many (e.g., about 600 to 2,500) small vertical passageways 222.

As shown, the horizontal passageways 220 may include a first horizontal passageway 224 that is circular and that extends through a center of the front face 206 to enter the body 202 and exits through a center of the rear face 208. The first horizontal passageway 224 may be referred to as a lateral passageway, as it may extend along a lateral direction A. A second horizontal passageway 226 may also be circular, extending through a center of the first side face 210 to enter the body 202, intersecting with the first horizontal passageway 224, and exiting through a center of the second side face 212. The second horizontal passageway 226 may be referred to as a longitudinal passageway, as it may extend along a longitudinal direction L that is perpendicular to the lateral direction A.

The vertical passageways 222 may include a plurality of smaller passageways arranged in a grid pattern (or alternatively in a non-grid arrangement) that extend through the top face 214 to enter the body 202 and intersect one or both of the first horizontal passageway 224 and the second horizontal passageway 226. The vertical passageways 222 may be referred to as transverse passageways, as they may extend along a transverse direction T that is perpendicular to both the lateral direction A and the longitudinal direction L.

Thus, the heat exchange block 200 may be structured to provide passage for gas (e.g., the waste gas 108/the flue gas 110) through the body 202 along three perpendicular directions (e.g., the horizontal (lateral and longitudinal) directions via the horizontal passageways 220, and the vertical (transverse) direction via the vertical passageways 222).

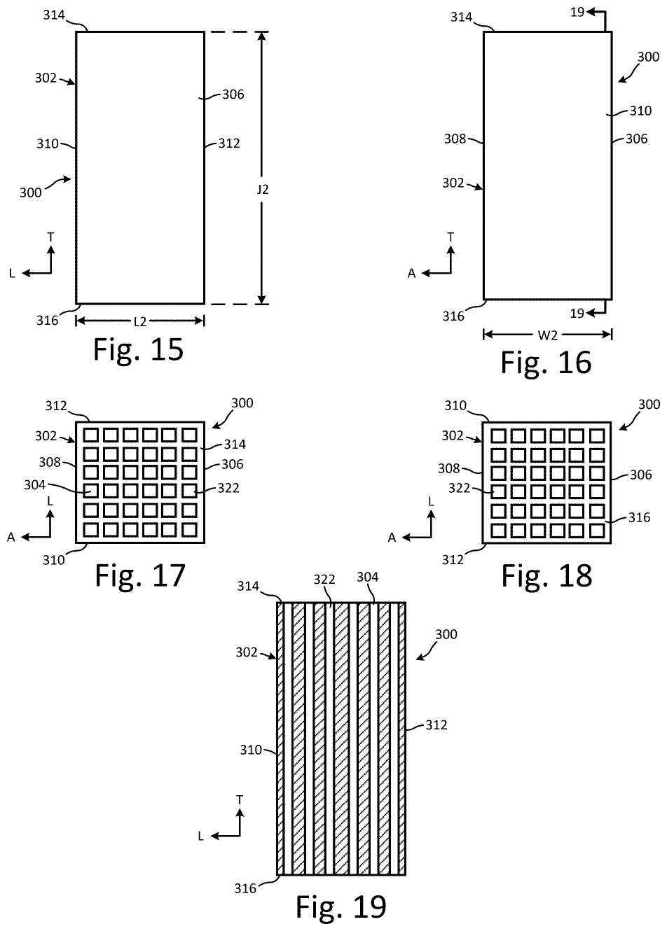

Referring to FIGS. 15 to 19, a heat exchange block 300 may be part of the heat exchanger 114, 134 of the RO 100 (as shown in FIGS. 3 to 6). For example, the plurality of blocks 116 may include a plurality of the heat exchange blocks 300. According to one embodiment, the heat exchange block 300 includes a body 302 with a plurality of passageways 304 extending therethrough.

The body 302 may be a rectangular prism (e.g., a cube or a cuboid). Alternatively, the body 302 may be another polygonal (e.g., hexagon, octagon), or non-polygonal shape. The body 302 may have a similar (e.g., the same) shape as the body 202 of the heat exchange block 200 shown in FIGS. 7 to 14, such that the heat exchange blocks 200, 300 are stackable.

As shown, the body 302 may include a front face 306 and a rear face 308 opposite one another with respect to a width W2 of the heat exchange block 300. The body 302 may further include a first side face 310 and a second side face 312 opposite one another with respect to a length L2 of the heat exchange block 300. According to one embodiment, the width W2 may be perpendicular to the length L2, and the first and second side faces 310, 312 extend between the front face 306 and the rear face 308 (e.g., from the front face 306 to the rear face 308). The opposed faces (the front face 306 and the rear face 308 and the first side face 310 and the second side face 312) may be the same such that they are interchangeable. According to one embodiment, the front, rear, first side, and second side faces 306, 308, 310, and 312 may all be the same such that they are interchangeable.

The body 302 may include a top face 314 and a bottom face 316 opposite one another with respect to a height J2 of the heat exchange block 300. As shown, the top face 314 and the bottom face 316 may be the same, such that they are interchangeable. According to one embodiment, the height J2 may be perpendicular to both the length L2 and the width W2, and the top and bottom faces 314, 316 may extend between the front face 306 and the rear face 308 (e.g., from the front face 306 to the rear face 308) and between the first side face 310 and the second side face 312 (e.g., from the first side face 310 to the second side face 312).

The plurality of passageways 304 may include vertical passageways 322. As shown, the heat exchange block 300 may be devoid of any horizontal passageways extending into the body 302 through the front face 306 (e.g., along a direction parallel to the width W2 such as the lateral direction A), the rear face 308 (e.g., along the direction parallel to the width W2), the first side face 310 (e.g., along a direction parallel to the length L2 such as the longitudinal direction L), or the second side face 312 (e.g., along the direction parallel to the length L2 such as the longitudinal direction L).

The vertical passageways 322 may extend into the body 302 through the top face 314 (e.g., along a direction parallel to the height J2 such as the transverse direction T) and exit the body 302 through the bottom face 316 (e.g., such that the vertical passageway 322 extends through an entirety of the body 302 along the height J2).

The vertical passageways 322 may include a plurality of passageways arranged in a grid pattern (or alternatively in a non-grid arrangement) that extend through the top face 314 to enter the body 302. According to some embodiments, the vertical passageways 322 may be arranged similarly to the vertical passageways 222, such that when the heat exchange block 300 is stacked on top of the heat exchange block 200 the vertical passageways 222 are aligned with the vertical passageways 322.

Thus, the heat exchange block 300 may be structured to provide passage for gas (e.g., the waste gas 108/the flue gas 110) through the body 302 along one direction (e.g., the vertical (transverse) direction via the vertical passageways 322).

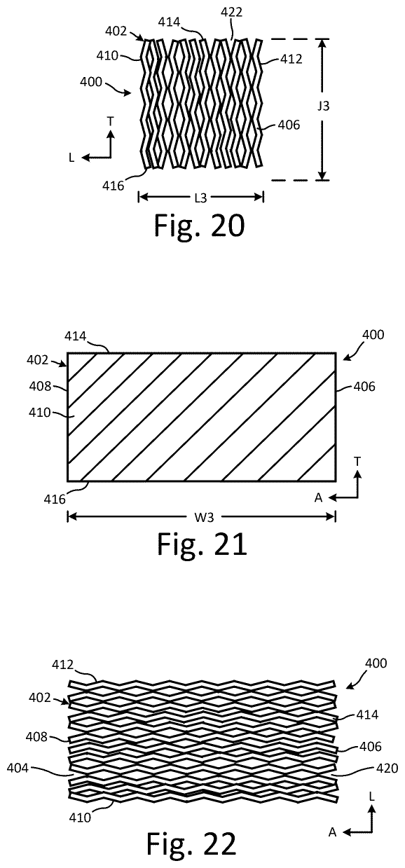

Referring to FIGS. 20 to 22, a heat exchange block 400 may be part of the heat exchanger 114, 134 of the RO 100 (as shown in FIGS. 3 to 6). For example, the plurality of blocks 116 may include a plurality of the heat exchange blocks 400. According to one embodiment, the heat exchange block 400 includes a body 402 with a plurality of passageways 404 extending therethrough.

The body 402 may be a rectangular prism (e.g., a cube or a cuboid). Alternatively, the body 302 may be another polygonal (e.g., hexagon, octagon), or non-polygonal shape. The body 302 may have a similar shape (e.g., one or more of the same outer dimensions) as the body 202 of the heat exchange block 200 and/or as the body 302 of the heat exchange block 300, such that the heat exchange blocks 200, 300, and 400 are stackable.

As shown, the body 402 may include a front face 406 and a rear face 408 opposite one another with respect to a width W3 of the heat exchange block 400. The body 402 may further include a first side face 410 and a second side face 412 opposite one another with respect to a length L3 of the heat exchange block 400. According to one embodiment, the width W3 may be perpendicular to the length L3, and the first and second side faces 410, 412 extend between the front face 406 and the rear face 408 (e.g., from the front face 406 to the rear face 408). The opposed faces may be the same such that they are interchangeable. For example, the front face 406 and the rear face 408 may be the same/similar. Additionally, the first side face 410 and the second side face 412 may be the same/similar.

The body 402 may include a top face 414 and a bottom face 416 opposite one another with respect to a height J3 of the heat exchange block 400. As shown, the top face 414 and the bottom face 416 may be the same, such that they are interchangeable. According to one embodiment, the height J3 may be perpendicular to both the length L3 and the width W4, and the top and bottom faces 414, 416 may extend between the front face 406 and the rear face 408 (e.g., from the front face 406 to the rear face 408) and between the first side face 410 and the second side face 412 (e.g., from the first side face 410 to the second side face 412). As shown, the body 402 may include layers of “waves” with peaks and valleys.

The plurality of passageways 404 may include horizontal passageways 420 and vertical passageways 422. As shown, the horizontal passageways 420 may extend into the body 402 through the front face 406 (e.g., along a direction parallel to the width W3 such as the lateral direction A) towards and through the rear face 408. According to one embodiment, the horizontal passageways 420 may be defined by adjacent ones of the layers of waves.

The vertical passageways 422 may extend into the body 402 through the top face 414 (e.g., along a direction parallel to the height J3 such as the transverse direction T) and exit the body 402 through the bottom face 416 (e.g., such that the vertical passageway 422 extends through an entirety of the body 402 along the height J3). According to one embodiment, the vertical passageways 422 may be defined by adjacent ones of the layers of waves.

As shown, the first side face 410 and the second side face 412 may be solid (e.g., devoid of passageways), such that the horizontal passageways 420 do not extend through the body 402 along the longitudinal direction L.

Thus, the heat exchange block 400 may be structured to provide passage for gas (e.g., the waste gas 108/the flue gas 110) through the body 402 along two directions (e.g., the horizontal (lateral) direction via the horizontal passageways 420 and the vertical (transverse) direction via the vertical passageways 422).

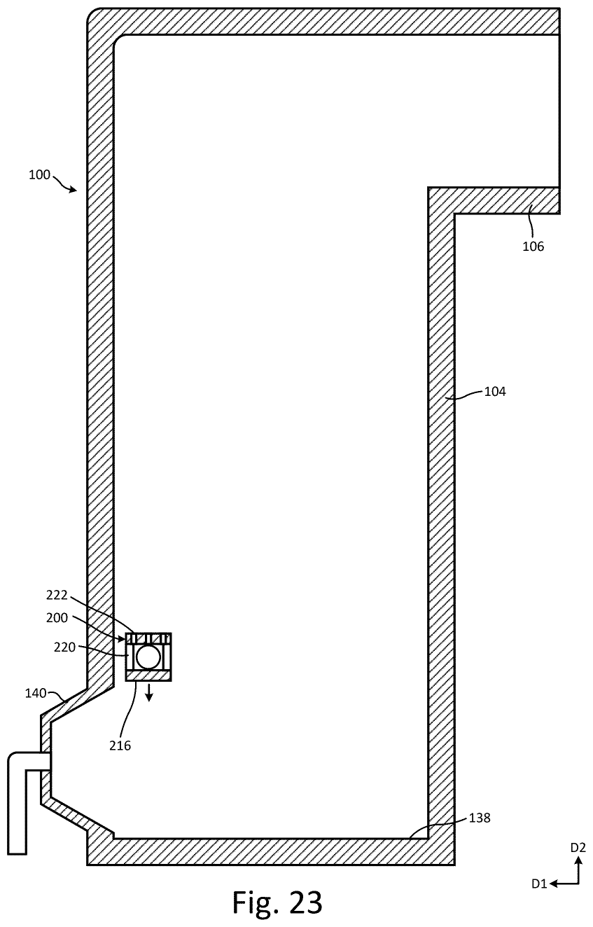

Referring to FIGS. 23 to 26, a heat exchanger (e.g., the first heat exchanger 114 and/or the second heat exchanger 134 of the RO 100 shown in FIGS. 3 to 6) may include a plurality of blocks stacked in a three dimensional array (e.g., to occupy an inner volume of a heat transfer chamber, such as the first heat transfer chamber 102 or the second heat transfer chamber 104). Although a limited number of blocks are shown in the illustrated embodiments, it will be appreciated that in some applications, up to thousands (e.g., tens of thousands) of blocks may be positioned within the heat transfer chamber to form the heat exchanger.

The three dimensional array of the plurality of blocks may include a plurality of two-dimensional layers stacked on top of each other. As shown in FIG. 23, the first (i.e., bottom) layer of the plurality of two-dimensional layers may include a plurality of heat exchange blocks that provide passage for gas (e.g., the waste gas 108/the flue gas 110) along three perpendicular directions (e.g., the horizontal (lateral and longitudinal) directions and the vertical (transverse) direction). According to one embodiment, the bottom layer may include a plurality of the heat exchange blocks 200. The heat exchange blocks 200 may be placed directly on the floor 138 of the heat transfer chamber 104, without the use of a coldface to support them. As shown, the bottom face 216 may abut the floor 138 and the inlet/outlet 140 may be aligned laterally with the heat exchange blocks 200 (e.g., along the first direction D1) such that the waste gas 108 enters the heat exchanger 134 via the horizontal passageways 220.

When supported by the floor 138 the vertical passageways 222 are oriented away from the floor 138 and toward the combustion chamber 106 providing a path for the waste gas 108 to pass through the heat exchange block 200. The larger horizontal passageways 220 promote (horizontal) distribution of the waste gas 108.

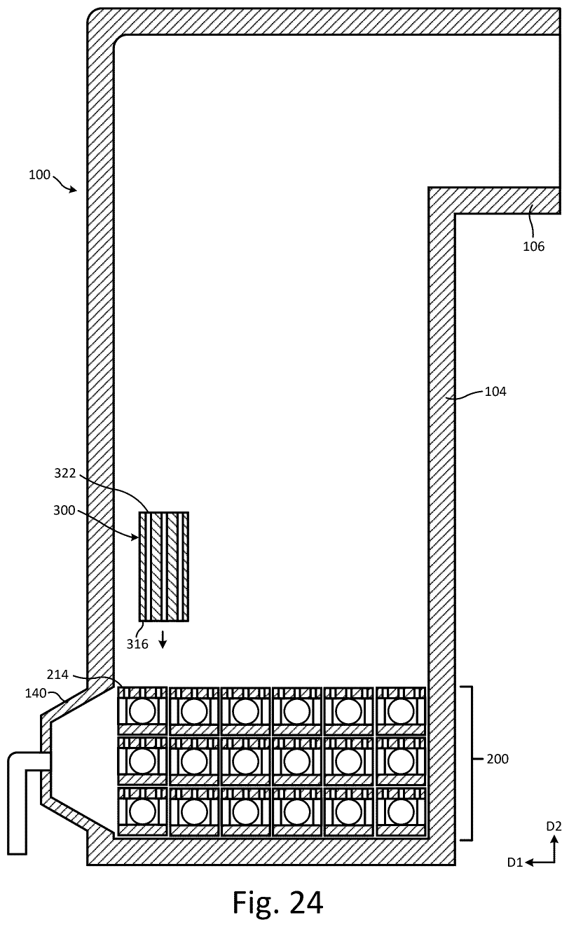

The heat exchanger 114, 134 may further include a plurality of layers of the heat exchange blocks 200. As shown in FIG. 24, the heat exchange blocks 200 may be stacked vertically to as to correspond to a height of the inlet/outlet 140. According to one embodiment, the heat exchanger 114, 134 may include between one and six (e.g., about three) layers of the heat exchange blocks 200.

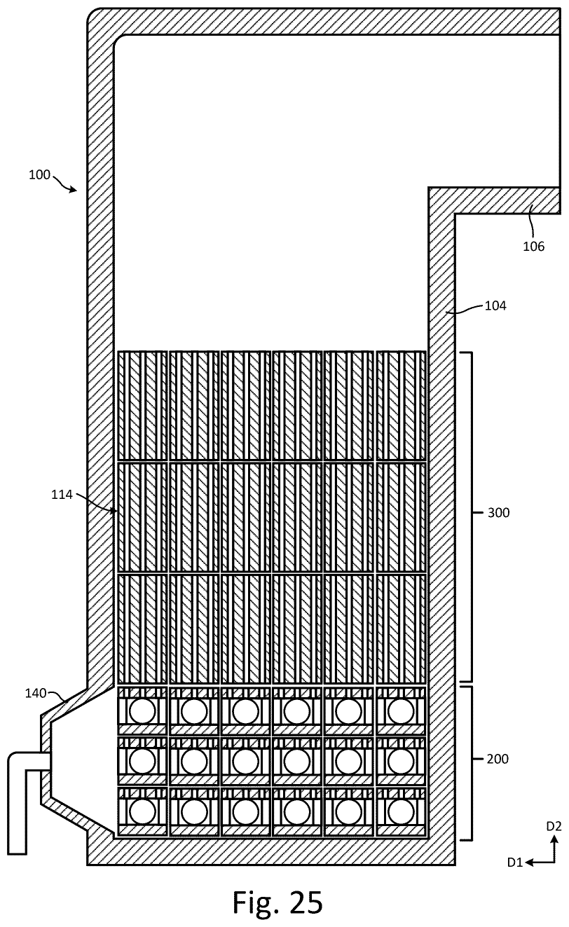

As shown in FIG. 24, a second portion of the three-dimensional array may include a plurality (e.g., one or more layers) of the heat exchange blocks 300. The heat exchange blocks 300 may be placed directly on the heat exchange blocks 200 (e.g., such that the bottom faces 316 of the heat exchange blocks 300 each abut the top faces 214 of the heat exchange blocks 200. As shown in FIG. 25, the vertical passageways 222 may be aligned vertically with the vertical passageways 322 (e.g., along the second direction D2) such that the waste gas 108 exits the heat exchange blocks 200 via the vertical passageways 222 and enters the heat exchange blocks 300 via the vertical passageways 322.

Additional layers (two-dimensional layers) of the heat exchange blocks 300 may be added until the interior volume of the heat transfer chamber 104 is fully occupied (e.g., to the desired amount). The heat exchange blocks 300 may be placed directly on other heat exchange blocks 300 (e.g., such that the bottom faces 316 of the “higher” heat exchange blocks 300 each abut the top faces 314 of the “lower” heat exchange blocks 300. As shown, the vertical passageways 322 of the higher and lower heat exchange blocks 300 may be aligned vertically (e.g., along the second direction D2) such that the waste gas 108 has a path through the heat exchange blocks 300 toward the combustion chamber 106.

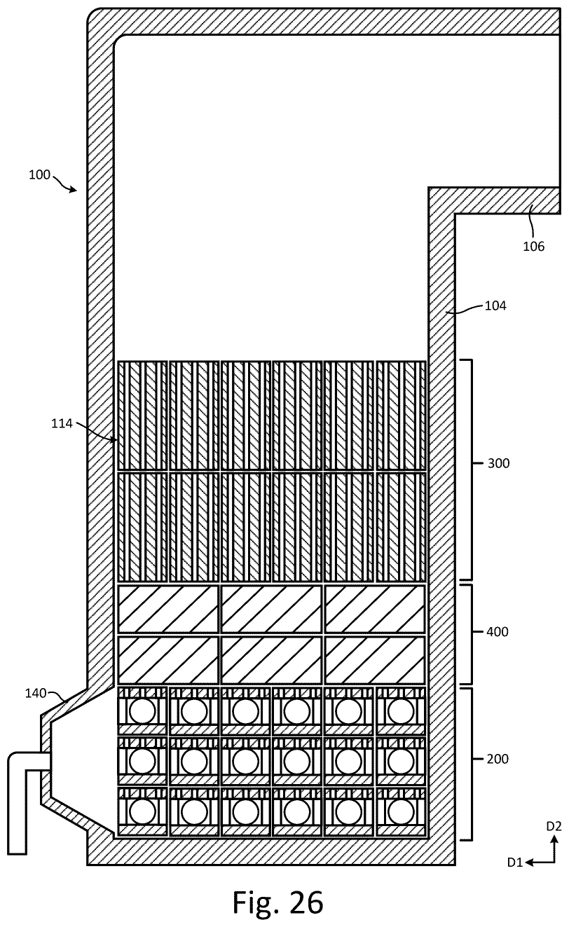

As shown in FIG. 26, a third portion of the three-dimensional array may include a plurality (e.g., one or more layers) of the heat exchange blocks 400. The heat exchange blocks 400 may be placed between the heat exchange blocks 200 and the heat exchange blocks 300.

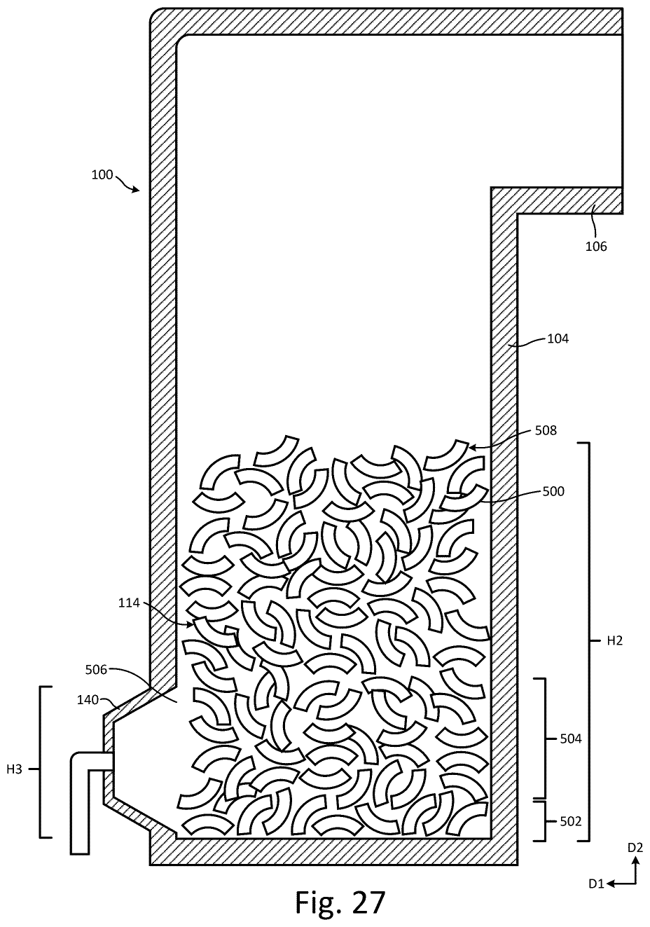

Referring to FIG. 27, a heat exchanger (e.g., the first heat exchanger 114 and/or the second heat exchanger 134 of the RO 100 shown in FIGS. 3 to 6) may include a plurality of pieces of random media 500 stacked in a three dimensional array (e.g., to occupy an inner volume of a heat transfer chamber, such as the first heat transfer chamber 102 or the second heat transfer chamber 104).

According to one embodiment, a method of assembling a heat exchanger (e.g., the heat exchanger 114) within a heat transfer chamber (e.g., the second heat transfer chamber 104) of a regenerative oxidizer (e.g., the RO 100) includes placing a plurality of pieces of heat exchange media 500 within the second heat transfer chamber 104. As shown, a first subset 502 of the plurality of pieces of heat exchange media 500 are supported by a floor (e.g., the floor 118) of the second heat transfer chamber 104.

The method may include stacking additional ones (e.g., a second subset 504) of the pieces of heat exchange media 500 on top of the first subset 502. The second subset 504 may be stacked within the second heat transfer chamber 104 such that the plurality of pieces of heat exchange media 500 of the second subset 504 are aligned with an opening 506 (e.g., formed where the inlet/outlet 140 intersects the second heat transfer chamber 104) along the horizontal direction D1. As shown, the opening 506 may be positioned above the floor 118 with respect to the vertical direction D2.

The method may further include increasing a height H2 of the stacked pieces of heat exchange media 500 until the height H2 of the stack 508 is greater than a height H3 of the opening 506. As shown, the height H2 and the height H3 may both be measured along the vertical direction D2.

A method of assembly of a heat exchanger may include the steps described above in reference to FIGS. 23 to 26.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The various embodiments described above can be combined to provide further embodiments.

Many of the methods described herein can be performed with variations. For example, many of the methods may include additional acts, omit some acts, and/or perform acts in a different order than as illustrated or described.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A regenerative oxidizer comprising:
a first heat transfer chamber;
a heat exchanger positioned within the first heat transfer chamber;
a second heat transfer chamber; and
a combustion chamber in fluid connection with both the first heat transfer chamber and the second heat transfer chamber,
wherein the regenerative oxidizer defines a fluid flow path that enters the first heat transfer chamber along a lateral direction through an opening that is aligned with a portion of the heat exchanger along the lateral direction, passes through the heat exchanger along a vertical direction that is perpendicular to the lateral direction, passes through the combustion chamber, enters the second heat transfer chamber, and then exits the second heat transfer chamber.

2. The regenerative oxidizer of claim 1 wherein the heat exchanger includes an array of blocks, and the portion of the heat exchanger includes at least one layer of blocks, each of the blocks of the at least one layer of blocks includes passageways that provide paths through the respective block along the lateral direction, the vertical direction, and a longitudinal direction that is perpendicular to both the lateral direction and the vertical direction.

3. The regenerative oxidizer of claim 2 wherein the at least one layer of blocks includes between 2 and 6 layers of blocks.

4. The regenerative oxidizer of claim 2 wherein the passageways include lateral passageways aligned with the lateral direction and vertical passageways aligned with the vertical direction, the lateral passageways being larger in size and fewer in number than the vertical passageways for each respective block of the at least one layer of blocks.

5. The regenerative oxidizer of claim 2 wherein the portion of the heat exchanger is a first portion, the heat exchanger includes a second portion, the second portion includes at least one layer of blocks of the array of blocks, each of the blocks of the second portion includes passageways that provide paths through the respective block along the vertical direction, and a body each of the blocks of the second portion is devoid of any passageways that provide a path through the respective block along the lateral direction or the longitudinal direction.

6. The regenerative oxidizer of claim 5 wherein the second portion is stacked on top of the first portion such that the passageways that provide paths through the respective blocks of the first portion along the vertical direction are aligned with the passageways that provide paths through the respective blocks of the second portion along the vertical direction.

7. The regenerative oxidizer of claim 1 wherein the heat exchanger is a first heat exchanger and the opening is a first opening, the regenerative oxidizer further comprising:
a second heat exchanger positioned within the second heat transfer chamber,
wherein the flow path passes through the second heat exchanger along the vertical direction after entering the second heat transfer chamber, and then exits the second heat transfer chamber along the lateral direction through a second opening that is aligned with a portion of the second heat exchanger along the lateral direction.

8. The regenerative oxidizer of claim 7 wherein the first opening and the second opening are aligned along the lateral direction.

9. The regenerative oxidizer of claim 7 wherein the fluid flow path passes through the second transfer chamber along the vertical direction.

10. The regenerative oxidizer of claim 1, further comprising:
one or more valves that transition to reverse the fluid flow path such that the fluid flow path enters the second heat transfer chamber along the lateral direction, passes through the second heat exchanger along the vertical direction, passes through the combustion chamber, enters the first heat transfer chamber, and then exits the first heat transfer chamber through the opening.

11. A method of assembling a heat exchanger within a heat transfer chamber of a regenerative oxidizer, the method comprising:
arranging a plurality of first heat exchange blocks in a first layer, each of the first heat exchange blocks including:
a lateral passageway that extends through a respective body of each of the first heat exchange blocks along a lateral direction; and
a plurality of vertical passageways that each extend through the respective body of each of the first heat exchange blocks along a vertical direction that is perpendicular to the lateral direction;
orienting the plurality of first heat exchange blocks in the first layer such that the lateral passageway of each of the first heat exchange blocks is aligned with an opening of the heat transfer chamber along the lateral direction;
arranging a plurality of second heat exchange blocks in a second layer, each of the second plurality of heat exchange blocks including:
a plurality of vertical passageways that each extend through a respective body of each of the second heat exchange blocks along the vertical direction; and
orienting the plurality of second heat exchange blocks in the second layer such that the plurality of vertical passageways of the first heat exchange blocks are aligned with the plurality of vertical passageways of the second heat exchange blocks along the vertical direction.

12. The method of claim 11, further comprising:
arranging additional ones of the first heat exchange blocks in a third layer stacked on top of the first layer and below the second layer; and
orienting the additional ones of the first heat exchange blocks in the third layer such that the lateral passageway of each of the additional ones of the first heat exchange blocks is aligned with the opening of the heat transfer chamber along the lateral direction.

13. The method of claim 12, further comprising:
arranging additional ones of the first heat exchange blocks in a fourth layer stacked on top of the third layer and below the second layer; and
orienting the additional ones of the first heat exchange blocks in the fourth layer such that the lateral passageway of each of the additional ones of the first heat exchange blocks is aligned with the opening of the heat transfer chamber along the lateral direction.

14. The method of claim 11 each of the first heat exchange blocks including:
a longitudinal passageway that extends through the respective body of each of the first heat exchange blocks along a longitudinal direction that is perpendicular to both the lateral passageway and the vertical passageway.

15. The method of claim 14 wherein the longitudinal passageway of each of the first exchange blocks intersects the lateral passageway of the respective first exchange block.

16. The method of claim 14 wherein the body of each of the second heat exchange blocks is devoid of both lateral passageways that extend through the respective body along the lateral direction and longitudinal passageways that extend through the respective body along the longitudinal direction.

17. The method ofclaim 14, further comprising:
arranging a plurality of third heat exchange blocks in an intermediate layer such that each of the third heat exchange blocks are stacked on top of the first heat exchange blocks and below the second heat exchange blocks, each of the third heat exchange blocks including:
a plurality of lateral passageways that extend through a respective body of each of the third heat exchange blocks along the lateral direction; and
a plurality of vertical passageways that each extend through the respective body of each of the first heat exchange blocks along a vertical direction that is perpendicular to the lateral direction.

18. A method of assembling a heat exchanger within a heat transfer chamber of a regenerative oxidizer, the method comprising:
placing a plurality of pieces of random heat exchange media within the heat transfer chamber such that the plurality of pieces are supported by a floor of the heat transfer chamber;
stacking additional ones of the random pieces of heat exchange media on top of the plurality of pieces supported by the floor such that the additional ones of the pieces of random heat exchange media are aligned with an opening of the heat transfer chamber along a horizontal direction, wherein the opening is above the floor with respect to a vertical direction that is perpendicular to the horizontal direction; and
increasing a height of a stack of the random pieces of heat exchange media until the height of the stack is greater than a height of the opening, wherein the height of the stack and the height of the opening are both measured along the vertical direction.

19. The method of claim 18 wherein the vertical direction is normal to the floor.

20. The method of claim 18 wherein the pieces of random heat exchange media are saddle, snowflake, dog bone, or bowtie shaped.
